(19) United States
(12) Patent Application Publication
(10) Pub. No.: US 2012/0029974 A1
(43) Pub. Date: Feb. 2, 2012

(54) COMPLEX SERVICE MODELING

(75) Inventors: Isaac G. Councill, San Jose, CA (US); Shun Jiang, Beijing (CN); Tobin J. Lehman, Cupertino, CA (US); James J. Rhodes, Los Gatos, CA (US); Hovey Raymond Strong, JR., San Jose, CA (US); Ruoyi Zhou, San Jose, CA (US)

(73) Assignee: International Business Machines Corporation, Armonk, NY (US)

(21) Appl. No.: 12/847,253

(22) Filed: Jul. 30, 2010

(51) Int. Cl. G06Q 10/00; G06F 17/30; G06F 3/00

(52) U.S. Cl. 705/7.35; 715/700; 707/705; 707/E17.01

(57) ABSTRACT

A deal management system is used to manage a complex service deal that defines various services to be fulfilled on behalf of a client. The deal management system includes a deal specification subsystem, a cost subsystem, and an estimation subsystem. The deal specification subsystem has a new deal interface to facilitate user specification of the complex service deal, including a plurality of service elements scheduled for fulfillment from a plurality of service delivery centers. The cost subsystem tracks an aggregate cost of a service delivery center that is arranged to fulfill a particular service element. The estimation subsystem dynamically evaluates accuracy of a deal cost model for the complex service deal during a duration of the particular service element by establishing a correlation between particular service elements within the complex service deal and portions of the aggregate cost data allocated to the corresponding service delivery center.

### BACKGROUND

There are currently many techniques in use today for companies to evaluate their cost of operations or sales. Some of the most common are cost accounting and ABC (Activity Based Costing). The general idea behind cost accounting is to generate the total cost and allocate that cost to individual items. In activity based costing, cost is associated with an activity and that activity is allocated to individual items.

In a traditional manufacturing model, these methods have had some success. A manufacturing environment is fairly static, i.e., the content of what the factory produces and what is needed to produce it usually does not change in immediate response to customer needs. For example, a factory which operates to produce widgets can't simply flip a switch to create TV's.

Compared with manufacturing processes, it is much more difficult to effectively model the cost of delivering services within complex service deals. Typical services engagements involve multiple types of services, delivery countries, and customer locations and are often spread across many years. When modeling the cost of these services, a company typically considers many different variables such as socio economic conditions of customer countries and delivery countries, demand for services being offered, technology needed to support the offering, etc. Thus, such modeling often involves a many-to-many relationship.

### SUMMARY

Embodiments of a system are described. In one embodiment, the system is a deal management system used to manage a complex service deal that defines various services to be fulfilled on behalf of a client. The deal management system includes a deal specification subsystem, a cost subsystem, and an estimation subsystem. The deal specification subsystem has a new deal interface to facilitate user specification of the complex service deal, including a plurality of service elements scheduled for fulfillment from a plurality of service delivery centers. The cost subsystem tracks an aggregate cost of a service delivery center that is arranged to fulfill a particular service element. The estimation subsystem dynamically evaluates accuracy of a deal cost model for the complex service deal during a duration of the particular service element by establishing a correlation between the particular service element within the complex service deal and a portion of the aggregate cost data allocated to the corresponding service delivery center. In some embodiment, the deal management system also includes a cost transformation subsystem to store a plurality of cost transformation models. Each cost transformation model is available to modify a generic predictive cost model for a specific service element according to known cost factors associated with a specific service delivery center. Other embodiments of the system are also described.

Embodiments of a computer program product are also described. In one embodiment, the computer program product includes a computer readable storage medium to store a computer readable program which, when executed on a computer, causes the computer to perform operations for modeling a complex service deal. Method embodiments corresponding to the operations of the computer program product embodiments are also described.

The operations of the computer readable program include presenting a lattice of service elements to a user. The operations also include receiving selections from the user to identify selected service elements for inclusion in the complex service deal. The operations also include accessing a generic predictive cost model for each selected service element. The operations also include defining a specific cost model for each selected service. The specific cost model at least partially depends on the generic predictive cost model for the selected service element in combination with a cost transformation model corresponding to a service delivery center with available resources for fulfilling the corresponding service element.

In further embodiments of the computer program product, the operations also include creating a volume model for modeling a number of transactions for the corresponding service element at the corresponding service delivery center and creating a productivity model for modeling a cost associated with each transaction corresponding to the service element and the service delivery center. In some embodiments, the operations also include attributing to a particular service element at least a portion of an actual aggregate cost associated with the corresponding service delivery center for fulfilling the particular service element. In some embodiments, the operations also include generating a graphical user interface to receive user input for attributing actual costs of the corresponding service delivery center to the particular service element. In some embodiments, the operations also include storing the actual aggregate cost associated with the corresponding service delivery center in a database of aggregate costs for a plurality of service delivery centers. In some embodiments, the operations also include generating a graphical user interface to receive user input for receiving the selections from the user to identify the selected service elements for inclusion in the complex service deal. The graphical user interface also presents locally relevant dimensions of a particular service delivery center to the user. In some embodiments, the operations also include storing information about prior deals in a database of prior deals, wherein the information comprises the generic predictive cost models for the selected service elements.

In another embodiment, the computer program product includes a computer readable program to perform operations for describing a deal cost model. The deal cost model is based on a combination of generic predictive cost models and cost transformation models. The generic predictive cost models correspond to service elements, and each service element represents a deliverable service with a defined scope and duration. The cost transformation models are applied to the generic predictive cost models, and each cost transformation model corresponds to a service delivery center with available resources for at least partially fulfilling the corresponding service element. The operations also include tracking aggregate cost data for at least one service delivery center. The aggregate cost data includes actual cost data for a plurality of services available through the service delivery center. The operations also include dynamically evaluating accuracy of the deal cost model during the duration of at least one of the service elements by establishing a correlation between particular service elements within the complex service deal and portions of the aggregate cost data allocated to a particular service delivery center. In some embodiments, this type of correlation can be made for individual service elements or for groups of service elements within the complex deal.

In further embodiments of the computer program product, the operations also include evaluating a specific cost model for a particular service element. The specific cost model is based on a combination of the generic predictive cost model and the cost transformation model for the particular service element. The specific cost model includes a volume model for modeling a number of transactions of the corresponding service element and a productivity model for modeling a cost of each transaction of the volume model, at a constant transaction level. In some embodiments, the operations also include adjusting the volume and productivity models for at least one active service element based on the accuracy of the deal cost model. The active service element has a future expected completion date. In some embodiments, the operations also include maintaining the volume and productivity models unchanged for at least one inactive service element, which has a past completion date. In some embodiments, the operations also include comparing an aggregate cost for the particular service delivery center with a sum of predicted costs for service elements delivered by the particular service delivery center and identifying an error term to describe a difference between the aggregate cost and the sum of the predicted costs for the service elements delivered by the particular service delivery center. In some embodiments, the operations also include determining whether the error term is within a range. In some embodiments, the operations also include making an incremental change to a parameter of at least one of the cost transformation models in response to a determination that the error term is outside of the range. The incremental change is subject to a change constraint which limits the incremental change. In some embodiments, the operations also include making an incremental change to a parameter of a specific cost model for a particular service element in response to a determination that the error term is outside of the range. The specific cost model is based on a combination of the generic predictive cost model and the cost transformation model for the particular service element, and the incremental change is subject to a change constraint which limits the incremental change. In some embodiments, the operations also include iteratively performing at least two of the following operations until a change in the error term from sequential iterations is below a threshold:
1. Calculating, based on an original volume estimate, a new volume estimate for fulfillment of at least one of the service elements at a selected service delivery center.
2. Determining, based on the new volume estimates, a new cost transformation model corresponding to the selected service delivery center. The new cost transformation model is related to a previous cost transformation model within a first bound.
3. Determining, based on the new volume estimates, a new specific predictive cost model for the corresponding service element. The new specific predictive cost model is related to a previous specific predictive cost model within a second bound.

The iterative process of producing new predictive cost models involves specific models (i.e., models related to instances of service elements within a particular deal). Generic predictive cost models are a result of combining (e.g., averaging) of specific models. Hence, as specific models are added and/or changed, generic models also change. The constraints on changing generic models may be explicit or handled implicitly by the constraints on changing specific models. In contrast, cost transformation models are an exception. Cost transformation models are generic in the sense that they do not relate to specific service elements or deals, but rather to particular service delivery centers. In most embodiments, bounds on changing cost transformation models are given explicitly.

In some embodiments, the operations also include using the deal cost model to calculate a cost of the complex service deal. The cost includes a historic cost and a predictive cost. The historic cost calculation is indicative of actual costs attributed to corresponding service elements within the complex service deal through a completed duration of the complex service deal. The predictive cost calculation is indicative of estimated costs expected to be incurred through a remaining duration of the complex service deal.

In some embodiments the operations include combining multiple specific cost models for the same service element to produce a new generic cost model for this service element. The new generic predictive cost model is related to a previous generic predictive cost model within a third bound. Other embodiments of the computer program product are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a complex service system.

FIG. 2 depicts a schematic diagram of one embodiment of a complex service deal with specific service instances that correspond with service elements from various service delivery centers.

FIG. 3 depicts one embodiment of an implementation of a specific cost model for a particular service element based on a generic cost model and a cost transformation model.

FIG. 4 depicts one embodiment of an implementation of a deal cost model based on a combination of generic cost models and cost transformation models.

FIG. 5 depicts a schematic block diagram of one embodiment of a deal management system.

FIG. 6 depicts a process flow diagram of one embodiment of a method for modeling a complex service deal.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a dynamic control system and method for evolving predictive cost models for financial measurements of complex service compositions. While building on previous systems and methods, embodiments described herein provide improvements in the areas of estimating the profitability of an active or prior deal, estimating costs for a proposed deal, and/or deriving a contingency cost for a proposed deal (based on the profitability of active and prior deals).

In one embodiment, the method includes converting an overdetermined system of actual data, guesses, and models into an improved set of guesses and set of predictive cost models. In some embodiments, the guesses are associated with activity based costing (ABC) and with volumes or quantities (e.g., hours or days) of services to be delivered within the scope of the complex service deal. The complex combination of services in a deal is decomposed, and templates are used to standardize modeling of the services and service elements. In general, service elements are definitions of one or more services that are available at a location or from a particular service provider source. The models may be improved gradually over time throughout the duration of a complex service deal in order to avoid abrupt and extreme changes in the models.

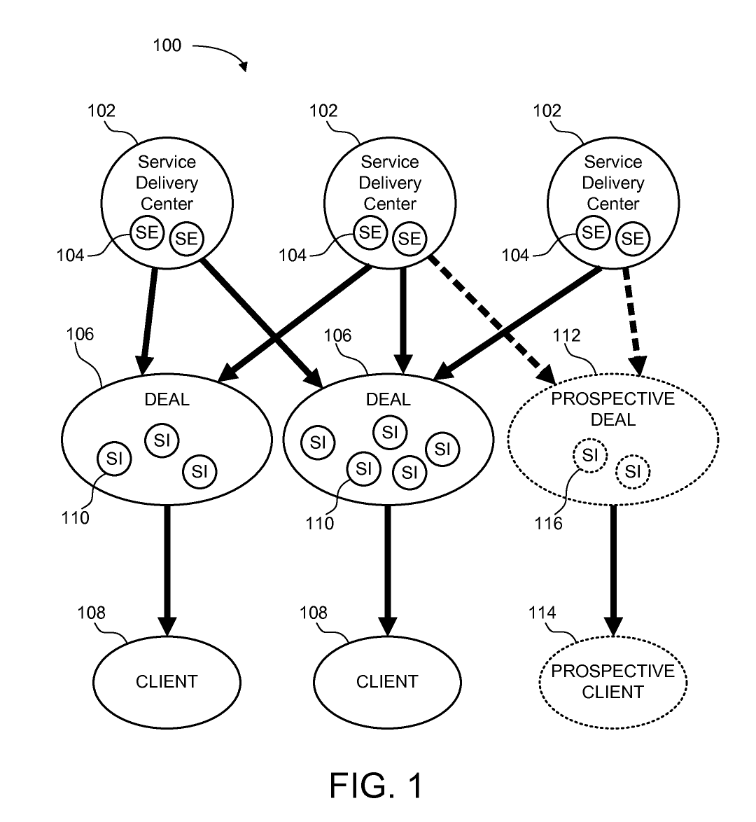

FIG. 1 depicts a schematic diagram of one embodiment of a complex service system 100. The illustrated service system 100 includes several service delivery centers 102. Each service delivery center 102 is capable of providing one or more service elements (SE) 104. The service elements 104 correspond to particular services, or bundles of services, that are available with defined characteristics. By making the service elements 104 in combination with one another, from the same or different service delivery centers 102, complex service deals 106 are formed to meet the needs of clients 108. As used herein, the specific instances of each service element 104 in a particular service deal 106 is referred to as a service instance (SI) 110. Prospective deals 112 are also compiled for prospective clients 114 based on prospective service instances 116.

One of the difficulties in putting together complex service deals 106 and prospective deals 112 is the complexity, or even inability, to accurately predict and track actual costs associated with each deal. Although costs may be tracked individually by each of the service delivery centers 102, the allocation of service elements 104 from different service delivery centers 102 to different service deals 106 makes it extremely difficult to identify the actual costs attributable to a single service element 104. Consequently, it is also extremely difficult to determine the cost of a complex service deal 106 because the costs of the individual service instances 110 are virtually unknown.

In order to more accurately predict, estimate, and track the costs of a complex service deal, service cost models may be implemented. A service cost model is a differential form from a manifold of the space, ζ, of descriptions of actual and possible deals for services to a space, $, of money. A deal in the space, ζ, has a duration and follows a trajectory over time. Integrating the service cost model over a finite interval of the trajectory of a deal yields a cost. Some examples of cost models include constant rate models, piecewise linear in time models, S-curve models, and so forth.

Service cost models can often be decomposed into a product of two models. One model is a volume model, for example, for services measured in transactions. The other model is a productivity model which indicates a cost per volume or transaction. Some examples of volume models include constant rate models, piecewise linear models, S-curve models, and periodic (sine wave or piecewise linear) models. Other volume models may be used in other embodiments. A productivity model can be a cost model at a constant volume, so some examples of cost models are also examples of productivity models.

Volume and productivity models are a subset of specific predictive cost models. While the description herein refers to embodiments which use volume and productivity models, the functionality described herein can be implemented regardless of whether or not volume and productivity models are used. For example, embodiments described below of the iterative generation of new specific predictive cost models can be implemented, whether they are composed of volume and productivity or not. In some embodiments, creating a new volume estimate is a special case of more generally creating a new estimate (i.e., guess) for a coefficient to be applied to a service element in an expression of a deal as a linear combination of service elements assigned to particular service delivery centers. Thus, the references herein to volume and productivity models are intended to provide examples of different embodiments, but other embodiments are not limited to the use of volume and productivity models.

Cost models are used to estimate the cost of providing a service. Simple (atomic) service elements 104 are associated with specific cost (i.e., productivity) models. A typical deal is a complex service, which can be decomposed into a lattice of services with service elements 104 at the leaves of the lattice. If accurate actual costs could be obtained for the service elements 104, and if accurate weights could be obtained for combining the costs of the service elements 104 into one aggregate cost for a particular complex service deal 106, then the profitability of the complex service deal 106 could be ascertained. However, neither accurate actual costs for service elements 104 nor accurate aggregation weights are available.

Although not available for individual service elements 104, accurate actual costs are sometimes available for aggregates of service elements 104 that correspond to the services delivered during a period of time by a specific service delivery center 102. However, as explained above, these aggregations do not usually correspond to particular service deals 106 because complex service deals 106 are typically facilitated by service elements 104 from various service delivery centers 102 and particular service delivery centers typically provide services for multiple complex service deals. Guesses may be made (e.g., using activity based costing) about weights to be assigned to service elements 104 within a service delivery center 102, and guesses may be made about weights to be assigned to service elements 104 within the complex service lattice of a deal 106.

Some embodiments described herein improve the guesses described above using actual cost data together with working hypotheses about correlations between the costs of delivery of the same service element 104 at various service delivery centers 102. One working hypothesis is that the rate of change of such correlation between service delivery centers 102 is so small that it can be ignored for multiple actual data collection periods. Alternatively, another hypothesis is that the rate of change of such correlation is predictable (e.g., because the second derivative is sufficiently small).

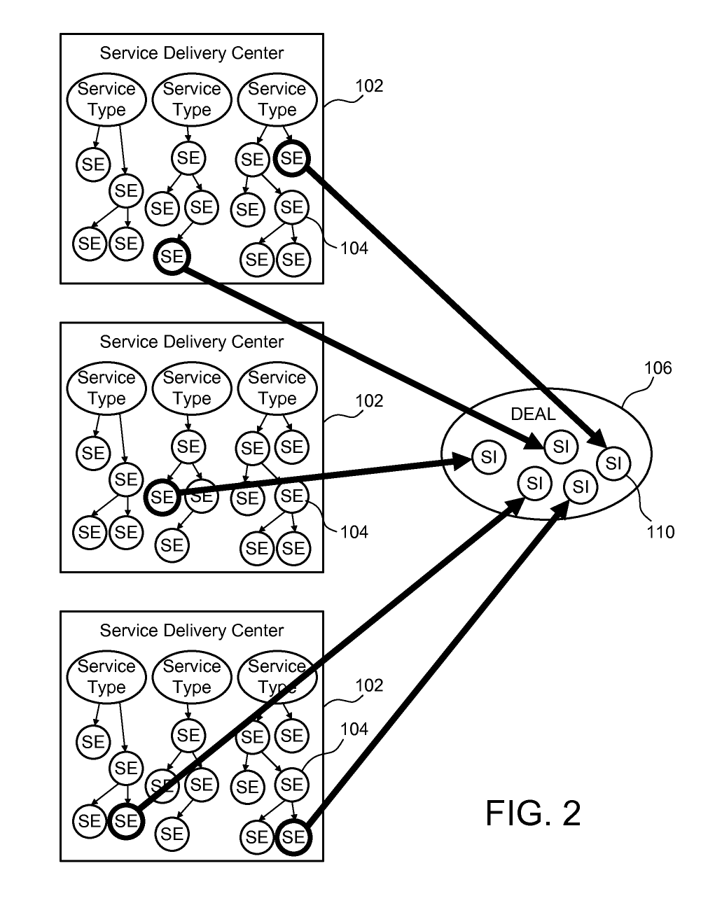

FIG. 2 depicts a schematic diagram of one embodiment of a complex service deal 106 with specific service instances 110 that correspond with service elements 104 from various service delivery centers 102. In the illustrated embodiment, the first (top) service delivery center 102 uses two service elements 104 to instantiate corresponding service instances 110 for the complex service deal 106. Similarly, the second (middle) and third (bottom) service delivery centers 102 use one and two, respectively, service elements 104 to instantiate corresponding service instances 110 for the complex service deal 106. In some embodiments, each deal 106 is a specified linear combination of services or service elements 104.

Each service delivery center 102 is shown with a lattice of possible service types and service elements 104. The service system 100 maintains a complex service as a lattice of complex services over leaf service elements 104, either at a centralized location or at each service delivery center 102. Additionally, the service system 100 also maintains corresponding aggregate cost models and service element cost models as well as estimated dynamically changing quantities of service at each service element (and aggregated up the lattice).

In one embodiment, the various service elements 104 are presented to a user via an interface such as a graphical user interface (GUI) for selection as part of a new or existing complex service deal 106. As one example, an intelligent GUI may be implemented to guide a user to construct (top-down) a lattice decomposition of a complex service into the standard service elements 104. The GUI also may facilitate matching partial descriptions to examples of service elements 104, for example, from previous service deals 106. Also, the GUI presents cost models for selection of estimated aggregation weights. The service elements 104 further may be listed to include itemized cost transformations listed by locally relevant dimensions. Some examples of locally relevant dimensions include, but are not limited to: geography of a service delivery center 102; name of the resource delivery center 102; the skill level associated with a resource available from a resource delivery center 102; the language proficiency of resource; and required service levels (e.g., response time). Other embodiments may utilize other locally relevant dimensions. By using locally relevant dimensions, the GUI may present locally relevant dimensions with example cost transformations for selection as part of a complex service deal 106 or for addition. In some embodiments, the service system 100 encourages standardization, but allows for addition of new local dimensions and new local values on new or old dimensions.

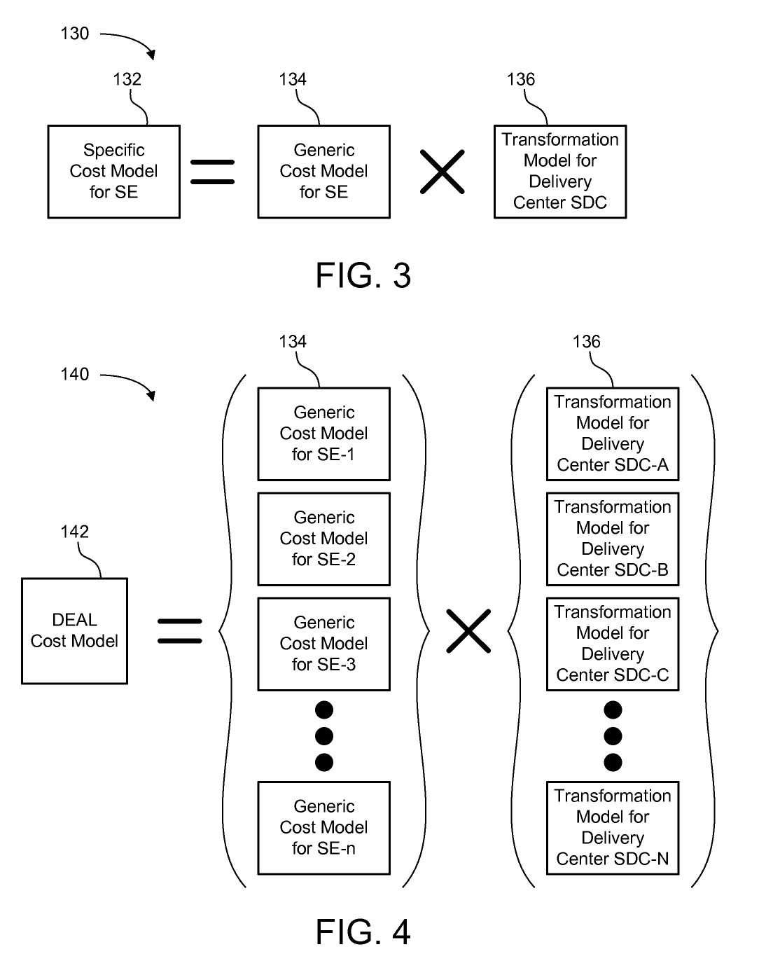

FIG. 3 depicts one embodiment of an implementation 130 of a specific cost model 132 for a particular service element 104 based on a generic cost model 134 and a cost transformation model 136. In general, the specific cost model 132 for the service element 104 provides a mechanism for estimating historical and future costs associated with delivery of services by the service element 104 within a particular complex service deal 106. For reference, the mathematical symbol ‘x’ used in the implementation 130 is representative of various potential mathematical operations, including simple multiplication or other linear or non-linear mathematical operations.

In order to obtain the specific cost model 132 for the service element 104, the generic cost model 134 is provided based on cost modeling for a standard (hypothetical or real) service delivery center 102. The service system 100 maintains, for each service type or service element 104, a set of generic parameter values in order to specify generic volume and productivity models. These generic parameters may be based on prior deal experience for all the service elements 104 that have appeared in a lattice under the given service type. Thus, a deal can be initially specified at a very high level as a linear combination of generic services, in order to obtain ballpark cost prediction. Eventually, each service can be completely specified in terms of service elements 104.

The specific cost model 132 for the service element 104 is obtained from a combination of the generic cost model 134 and a cost transformation model 136 that is specific to the corresponding service delivery center 102 which instantiates the service instance 110 for the corresponding service element 104. Costs at service delivery centers 102 can be decomposed into (1) costs associated with labor and affected by productivity and (2) overhead costs intrinsic to the service delivery center 102, independent of labor. Labor rates change according to regulatory and market forces that, in some embodiments, are assumed to be reasonably predictable. Changes in other (i.e., non-labor) overhead costs also may be similarly assumed reasonably predictable. Thus, models can be generated for the transformation in costs from one service delivery center 102 to another and, more specifically, from the standard service delivery center which is used to provide the generic cost model 134. In this way, cost transformation models 136 help to predict the appropriate cost transformation over the lifetimes of deals. Consequently, the cost transformation models 136 are prospective—they are not retrospective. In some embodiments, cost transformation models 136 are extrapolations from trends observed in actual costs. Also, in some embodiments, cost transformation models are functions from the set of pairs of the form (delivery center, time period) to the set of linear transformations of cost models.

FIG. 4 depicts one embodiment of an implementation 140 of a deal cost model 142 based on a combination of generic cost models 134 and cost transformation models 136. In general, the deal cost model 142 provides a mechanism for estimating historical and future costs associated with a particular complex service deal 106. For reference, the mathematical symbol ‘x’ used in the implementation 140 is representative of various potential mathematical operations, including simple multiplication or other linear or non-linear mathematical operations. In one embodiment, the individual generic cost models 134 are combined with the corresponding cost transformation models 136, and the resulting combinations are summed together to indicate the estimated cost of the complex service deal 106. Other embodiments may use other mathematical algorithms to generate the deal cost model 142 from the generic cost models 134 and the cost transformation models 136.

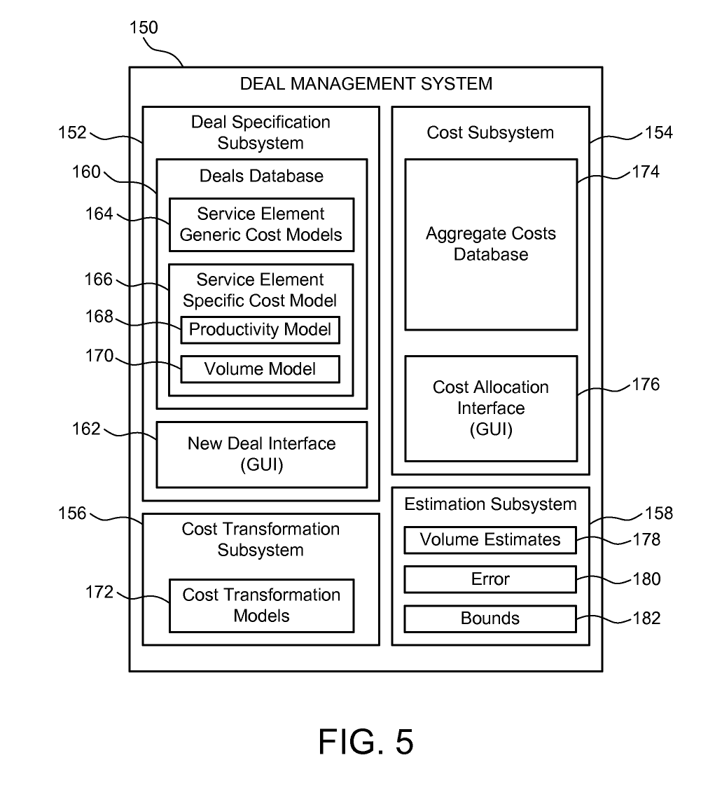

FIG. 5 depicts a schematic block diagram of one embodiment of a deal management system 150. The illustrated deal management system 150 includes various components which are capable of performing the functions and operations described herein. In one embodiment, at least some of the components of the deal management system 150 are implemented in a computer system. For example, the functionality of one or more components of the deal management system 150 may be implemented by computer program instructions stored on a computer memory device and executed by a processing device such as a central processing unit (CPU).

In general, the functionality implemented by the deal management system 150 includes standardizing complex service decompositions into service elements 104 and maintaining predictive cost models for the service elements 104. The deal management system 150 also provides costing data (e.g., ABC) from actual experiences and maintains reasonably accurate predictive models for cost-of-living transformations for non-productivity related costs among service delivery centers 102. Embodiments of the deal management system 150 also maintain and dynamically improve both guesses and models from actual data.

The depicted deal management system 150 includes a deal specification subsystem 152, a cost subsystem 154, a cost transformation subsystem 156, and a cost estimation subsystem 158. In one embodiment, each subsystem is a functionally independent portion of the deal management system 150, although the separate subsystems may interact with one another to achieve the overall functionality of the deal management system 150.

The illustrated deal specification subsystem 152 includes a deals database 160 and a new deal interface 162. In general, the deals database 160 stores various information on past, current, and/or prospective service deals 106. Some of the deals may be considered and used as benchmark deals. In a specific embodiment, the deals database 160 stores various models related to the service deals 106, including generic cost models 164 and specific cost models 166 for individual service elements 104. The generic cost models 164 may be created from templates using parameters specified in a catalog within the deals database 160. In some embodiments, the specific cost models 166 include both productivity models 168 and volume models 170. In other embodiment, the volume models 170 may be omitted.

A typical service can be represented by two templates. The first template is a function of zero or more parameters that produces a productivity model 168. The second template is a function of zero or more parameters that produces the volume model 170. Alternatively, a service may be represented by one template which includes a function of zero or more parameters that produces a cost model.

A service is either a specified linear combination of (one or more) services or a service element 104. In one embodiment, a service element 104 is a service for which the template has only parameters that are determined by specifying a service delivery center 102. The volume model 170 for a service element 104 has no parameters. Specifying the particular service delivery center 102 provides the values of productivity template parameters for a service element 104 so that the service element 104 at a service delivery center 102 has both a volume model 170 and a productivity model 168.

The new deal interface 162 facilitates receiving user input to specify any of the parameters for a service deal 106. In one embodiment, the new deal interface 162 generates a graphical user interface (GUI) that allows the user to see typical input selections, enter parameters, select service elements 104, and perform the other functions for defining a particular service deal 106, in either a general or specific manner.

The illustrated cost subsystem 154 includes an aggregate costs database 174 and a cost allocation interface 176. The aggregate costs database 174 stores actual aggregate costs for one or more service delivery centers 102. The actual aggregate costs may be available from each service delivery center 102 on a regular (e.g., monthly or quarterly) basis.

The cost allocation interface 176 allows the user to attribute some or all of the actual aggregate costs of the service delivery center 102 to a particular service element 104 available through the service delivery center 102. In one embodiment, the cost allocation interface 176 is implemented as a GUI that displays the actual aggregate costs to the user and allows the user to see and modify services or service elements 104 to which the costs are attributed, as well as attribution weights for each service or service element 104. In this way, a user may edit how the actual aggregate costs are attributed to various services or service elements 104. In other words, the cost allocation interface 176 provides for the input of educated guesses, where necessary, in order to attribute this cost data to specific instances 110 of service elements 104 associated with specific deals 106 for which each service delivery center 102 is supplying service. In some embodiments, non-labor overhead costs at a particular service deliver center 102 are assumed to be attributed proportionally among the various service elements 104 according to the attribution of labor costs. Other embodiments may use other formulations for the labor and/or non-labor costs.

The cost transformation subsystem 156 generally facilitates management of one or more cost transformation models 172. In one embodiment, the cost transformation subsystem 156 dynamically maintains (e.g., stores and updates) cost transformation models 172 for various service delivery centers 102 so that the general cost models 164 can be modified to generate the specific cost models 166 for specific service delivery centers 102.

The estimation subsystem 158 uses the various models within the deal management system 150 to generate estimations about the costs and/or profitability of certain service deals 106. In one embodiment, the estimations include predictions, or forecasts, of future financial positions (e.g., expenses, profitability, etc.) related to the service deals 106. In some embodiments, the estimations include calculations of historical financial data related to the service deals 106. In other embodiments, the estimations include a combination of historical calculations and future predictions.

While there are various ways in which the financial positions of a particular service deal 106 might be estimated, some embodiments of the estimation subsystem 158 use initial volume estimates 178, or guesses, as a starting point for estimating the costs associated with each service deal 106. The volume estimates 178 may be used in conjunction with one or more of the models described herein, for example, as an input parameter.

Although many embodiments are described herein with reference to the use of initial estimates or guesses, other embodiments may be implemented which are independent of initial estimates or guesses. Initial guesses may be used to express a deal as a linear combination of service elements. However, embodiments of the iterative process described herein can revise the coefficients of these linear combinations arbitrarily in order to best fit the accurate aggregate actual costs reported by service delivery centers 102. There are many situations in which these coefficients are expected to change from month to month in the model of a particular deal 106, even when the specific cost models for each service element do not change. Thus, in some embodiments the new specific models can be independent of initial guesses.

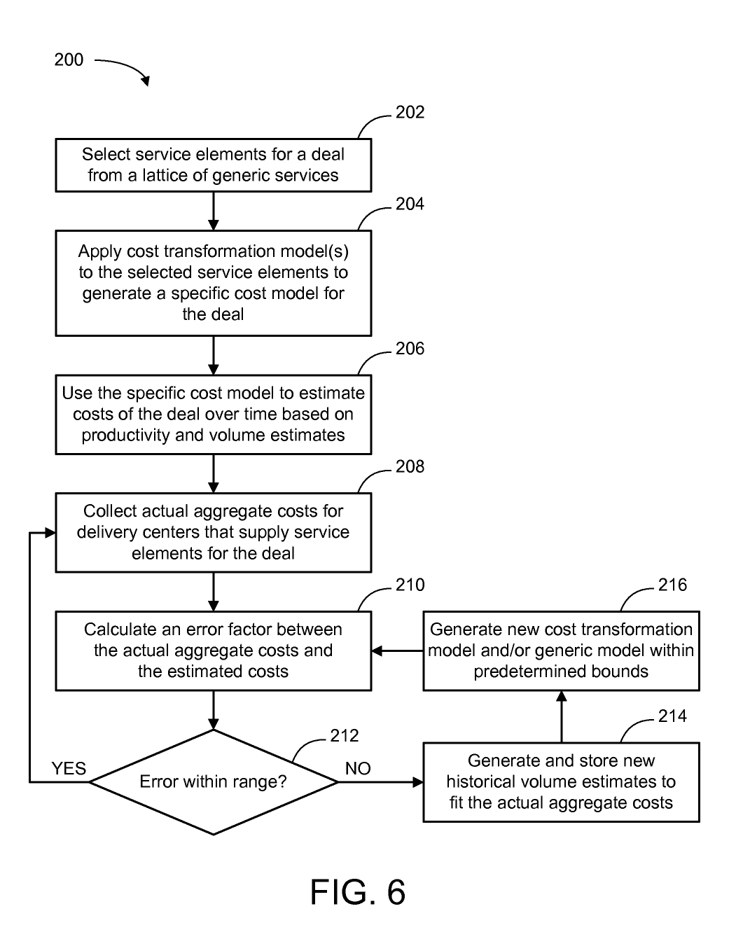

Also, as explained in more detail below with reference to the method 200 of FIG. 6, some embodiments of the estimation subsystem 158 also use error calculations 180 and bound limits 182 related to the financial estimations. In one embodiment, the error calculations 180 refer to differences between expected estimations produced by the models and actual costs attributed a particular service element 104 at a service delivery center 102. Calculating this type of error 180 allows the deal management system 150 to refine the models and decrease or minimize difference between the estimated costs and the attributed actual costs. The bounds 182 refer to parameters which indicate a limit as to how much, or to what degree, a model might be changed during iterative computations while decreasing or minimizing the error calculation 180. By limiting how drastically a model might be changed between iterations, it may be possible to avoid changing a model too much in response to a single anomalous cost report.

FIG. 6 depicts a process flow diagram of one embodiment of a method 200 for modeling a complex service deal 106. Although the method 200 is described in conjunction with the service system 100 of FIG. 1 and the deal management system 150 of FIG. 5, embodiments of the method 200 may be implemented with other types of service systems and/or deal management systems.

In general, embodiments of the method 200 are implemented to dynamically improve the guesses (e.g., attribution weights, cost models, and cost transformation models) used by the deal management system 150. The deal management system 150 starts with an overdetermined system that includes actuals, cost models, cost transformation models, and guesses (e.g., volume estimations 178). The deal management system 150 solves the overdetermined system for new guesses that best fit the actuals, cost models, and cost transformation models. The deal management system 150 then solves the new overdetermined system for new cost transformation models that best fit the other components, subject to a bound (e.g., a bound 182) on the change to each cost transformation model. In one embodiment, these operations are then iterated until there is essentially no change in the cost transformation model from one iteration to the next. In an alternative embodiment, these intermediate iterations for the cost transformation model can be omitted. The deal management system 150 then solves the new overdetermined system for new specific cost models that best fit the other components, subject to a bound (e.g., another bound 182) on the change to each specific cost model. In one embodiment, all of these operations are then iterated until there is essentially no change in the cost model from one iteration to the next. Thresholds and/or ranges can be used to determine when the changes in the cost transformation models and/or the cost models are small enough from one iteration to the next. The deal management system 150 then outputs the new guesses and models. This process may be repeated on a regular basis, for example, after new actual cost information is received.

In some embodiments, initial guesses for the volume estimations are not necessary. However, in some embodiments with initial guesses, potential ties for best fit might arise and closeness to the original guesses provides a way to break ties. The initial guesses can also be used to improve performance of best fit calculations.

Also, there are many ways to place bounds on changes in models. One way is to limit the maximum change in any parameter. Another way is to limit the result of integrating the model difference over the period of the deal. Other embodiments may use other ways to designate bounds or enforce changes within a certain limit.

With specific reference to the method 200 shown in FIG. 6, the deal management system 150 allows a user to define a complex service deal 106 by selecting 202 service elements 104 from a lattice of generic services. The deal management system 150 then applies 204 cost transformation models to the selected service elements 104 to generate specific cost models 166 for the deal 106. The deal management system 150 uses 206 the specific cost models to estimate costs of the deal 106 over time. These estimations may include historical calculations and/or future predictions based on productivity and volume models/estimates. The deal management system 150 also collects 208 actual aggregate costs for delivery centers 102 that supply resources or service elements 104 for the deal 106.

Based on the actual aggregate costs and the estimated costs, the deal management system 150 calculates 210 an error factor 180 between the actual aggregated costs and the estimated costs. This error factor is based on all active deals supported by a collection of at least one delivery center. In some embodiments, the error factor is a sum of absolute values of deviations between delivery center actual aggregate costs and corresponding costs predicted by specific cost models. In other embodiments the error factor is a sum of squares of these deviations. Other embodiments may use other algorithms or approaches to calculate the error factor.

The deal management system 150 then determines 212 if the error is within a specified range. If the error is within the specified range, then the models are assumed to be relatively accurate, and the deal management system 150 continues to collect aggregate costs and calculate error factors at subsequent intervals. If the error is not within the specified range, then, in some embodiments, the deal management system 150 generates and stores 214 new historical volume estimates to fit the actual aggregate costs. The deal management system 150 also generates 216 new models that are designed to better fit the actual cost data. The new models may include new cost transformation models, new specific cost models, and/or other types of new models. In one embodiment, the amount of change to each model is kept within a bound that is specified for the corresponding type of model. The depicted method 200 then ends.

The following description provides one example of using an embodiment of the service system 100 described above. Calculations in the following example are illustrative, and the best fit values are merely hypothetical examples that may or may not correlate to a specific measure of fit using, for example, minimizing sum of squares of deviations, or minimizing sum of absolute values of deviations, or another similar algorithm.

This example assumes that the second period of operation has completed. This example is based on a single service deal 106 (Deal1) facilitated during the first period of operation by service elements 104 from only one service delivery center 102 (Center1). During the second period of operation, Deal1 is also facilitated by service elements 104 from a second service delivery center 102 (Center2).

| Actuals | | 1.00 | 2.00 |
|---|---|---|---|
| expense | | | |
| labor (including utilization overhead) | | 9.00 | 20.00 |
| Center1 | | 9.00 | 10.00 |
| Center2 | | | 10.00 |
| overhead (non labor) | | 1.00 | 4.00 |
| Center1 | | 1.00 | 2.00 |
| Center2 | | | 1.00 |
| revenue | | | |
| volume | | | |
| Deal1 | | | |
| a | | 5.00 | 5.00 |
| b | | 10.00 | 10.00 |
| Deal2 | | | |
| b | | | 5.00 |
| c | | | 6.00 |
| date-time | | | |
| start | | | |
| Deal1 | | | |
| a | Center1 | 1 | |
| b | Center1 | 1 | |
| | Center2 | 2 | |
| Deal2 | | | |
| b | Center1 | 2 | |
| | Center2 | 2 | |
| c | Center2 | 2.00 | |

| | |
|---|---|
| overhead adjustment (e.g. for currency | |
| fluctuations) | |
| Center1 | |
| Center2 | 1.00 |

In this example, the following models are used:

| Models | | | | | | | | |
|---|---|---|---|---|---|---|---|---|
| productivity | | | | | | | | |
| adjustment | | | | | | | | |
| Center1 | | | | | | | | |
| a | 0.00 | 0.00 | 0.00 | 0.00 | 0.00 | 0.00 | 0.00 | 0.00 |
| b | 0.00 | 0.00 | 0.00 | 0.00 | 0.00 | 0.00 | 0.00 | 0.00 |
| Center2 | | | | | | | | |
| b | 0.20 | 0.20 | 0.20 | 0.20 | 0.20 | 0.20 | 0.20 | 0.20 |
| c | 0.20 | 0.20 | 0.20 | 0.20 | 0.20 | 0.20 | 0.20 | 0.20 |
| productivity | | | | | | | | |
| a | 2.00 | 2.00 | 2.00 | 3.00 | 4.00 | 5.00 | 5.00 | 5.00 |
| b | 1.50 | 1.50 | 1.50 | 2.00 | 3.00 | 4.00 | 4.00 | 4.00 |
| c | 1.00 | 1.00 | 1.25 | 1.50 | 1.75 | 2.00 | 2.00 | 2.00 |

Independent parameters of the models are underlined. The productivity adjustment models are constant for each service delivery center 102. Each has exactly one independent parameter. The productivity models are piecewise linear with three independent parameters for each service.

Note that we have actual total volumes in this example. We will solve for the best fit volume attributions and make the attributions of expense to deal proportional. In our simple example, volume attributions for service b are the only guesses. We begin with the following (optional) guesses for volume attributions:

| Guesses | | | |
|---|---|---|---|
| attributions | | | |
| volume | | | |
| Deal1 | | | |
| a | Center1 | 5.00 | 5.00 |
| b | Center1 | 10.00 | 5.00 |
| | Center2 | | 5.00 |
| Deal2 | | | |
| b | Center1 | | 2.00 |
| | Center2 | | 3.00 |
| c | Center2 | | 6.00 |

The two independent parameters for guesses are underlined. All other parameters are determined by these guesses and the actual total volumes above. In this example, the models are used (Step 1) to solve for the best fit for the independent parameters, and a solution of (4.00, 0.00) is obtained, as shown below:

| Guesses | | | |
|---|---|---|---|
| attributions | | | |
| volume | | | |
| Deal1 | | | |
| a | Center1 | 5.00 | 5.00 |
| b | Center1 | 10.00 | 4.00 |
| | Center2 | | 6.00 |
| Deal2 | | | |
| b | Center1 | | 0.00 |
| | Center2 | | 5.00 |
| c | Center2 | | 6.00 |

In order to keep the models from changing too rapidly as a function of anomalous actual data, a tight initial limit of 0.3 is maintained on the change in the parameter for productivity adjustment, and an initial limit of 0.03 is maintained on the change in any parameter for productivity. The models are then used (Step 2) to solve for the best fit for the productivity adjustment parameters, and a solution of (0.01, 0.23) is obtained. The models are then used (Step 3) to solve for the best fit for the productivity model parameters, and a solution of (1.97, 1.53, 1.00) is obtained for the only relevant parameters (for a, b, and c, respectively).

The bounds are then changed from (0.3, 0.03) to (0.15, 0.015). Although this example changes the bounds by 50%, other embodiments may use other percentages (or other numerical values) to adjust the bounds in a decreasing manner. After changing the bound, the previous steps are then repeated. In Step 1, the new best fit for the volume guesses is (4.00, 0.00), which is the same as before. In Step 2, the new best fit for productivity adjustment parameters is (0.00, 0.245). In Step 3, the new best fit for productivity parameters is (1.955, 1.535, 1.00).

In this example, convergence is defined as no change in any parameter greater than 0.005. Under this definition, the next iteration converges. However, other embodiments may use other convergence thresholds. The result is a new set of guesses and updated models. Expense guesses are attributed proportionally to volume guesses.

| Guesses | | | |
|---|---|---|---|
| attributions | | | |
| volume | | | |
| Deal1 | | | |
| a | Center1 | 5.00 | 5.00 |
| b | Center1 | 10.00 | 4.00 |
| | Center2 | | 6.00 |
| Deal2 | | | |
| b | Center1 | | 0.00 |
| | Center2 | | 5.00 |
| c | Center2 | | 6.00 |
| expense | | | |
| Center1 | | | |
| a | | 5.00 | 6.67 |
| b | | 5.00 | 5.33 |
| Center2 | | | |
| b | | 0.00 | 6.00 |
| c | | 0.00 | 6.00 |

Consequently, the models are updated as follows:

| Models | | | | | | | | |
|---|---|---|---|---|---|---|---|---|
| productivity | | | | | | | | |
| adjustment | | | | | | | | |
| Center1 | | | | | | | | |
| a | 0.00 | 0.00 | 0.00 | 0.00 | 0.00 | 0.00 | 0.00 | 0.00 |
| b | 0.00 | 0.00 | 0.00 | 0.00 | 0.00 | 0.00 | 0.00 | 0.00 |
| Center2 | | | | | | | | |
| b | 0.25 | 0.25 | 0.25 | 0.25 | 0.25 | 0.25 | 0.25 | 0.25 |
| c | 0.25 | 0.25 | 0.25 | 0.25 | 0.25 | 0.25 | 0.25 | 0.25 |
| productivity | | | | | | | | |
| a | 1.95 | 1.95 | 1.95 | 3.00 | 4.00 | 5.00 | 5.00 | 5.00 |
| b | 1.54 | 1.54 | 1.54 | 2.00 | 3.00 | 4.00 | 4.00 | 4.00 |
| c | 1.00 | 1.00 | 1.25 | 1.50 | 1.75 | 2.00 | 2.00 | 2.00 |

In some embodiments, the foregoing example may extend to illustrate additional functionality. For example, the previous example assumed actual aggregate volume information (with revenue based on volume so that volume is measured). For some service offerings and parts of service offerings, actual aggregate volume by deal and by (atomic) service may be unavailable. In this case, the system is still overdetermined and the method can still apply with no constraints on the guesses for volume. The models still provide best fit guesses. There are simply more parameters so the solution involves searching a higher dimensional space for best fit. The system can also change so that the productivity models become simple cost models (removing volume altogether from the system). Other embodiments may be used in other manners.

Some embodiments of the service system 100 and the method 200 described herein facilitate improvements in estimating the profitability of an active or prior deal. In particular, they provide a dynamic way to improve the attribution of cost to a particular deal, rather than relying solely on estimations from activity based costing and guesses.

As one alternative to the embodiments described above, some embodiments apply the described method after all revenue for a deal has been generated, allowing larger changes to models in order to produce models that improve the fit to actual data. Then the best fit guesses can be used to improve the cost attribution and profit estimation. This alternative would be appropriate for deciding whether a given deal met profitability thresholds. Characteristics of deals could then be examined for correlation with profitability. In one embodiment, a weighted best fit with exponentially smaller weights associated with older data is performed for best fit to historical data. Other embodiments may use other approaches to determine the best fit to historical data.

As another alternative, an embodiment of the method could be applied iteratively, one revenue time period at a time, until all revenue received and all actual costs have been estimated. This alternative could provide a systematic and reasonably fair way of comparing past deals with currently active deals.

Some embodiments of the service system 100 and the method 200 described herein also facilitate estimating costs for a proposed deal. Improved cost models can be created for instances of service elements in specific deals. In order to evolve generic cost models, the generic parameters can be adjusted to best fit the history of prior deals. Then bounded adjustments can be made to the generic cost model based on changes to specific cost models for active deals. In some embodiments, best fit can be applied to an exponentially weighted average of prior deals in order to emphasize recent experience over long past experience.

Some embodiments of the service system 100 and the method 200 described herein also facilitate deriving a contingency cost for a proposed deal (based on the profitability of active and prior deals). In general, the price of a proposed deal can be based on a combination of the cost estimate, the contingency estimate, and an amount of profit. By applying embodiments of the method described above to prior deals, improved cost estimates can be obtained for relevant service elements and complex services in these deals. The variability of these estimated costs is then used in order to provide a confidence interval or confidence bound (one-sided confidence interval) around cost estimates for the proposed deal.

An embodiment of the service system 100 includes at least one processor coupled directly or indirectly to memory elements through a system bus (or other communication channel) such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including the operations described in conjunction with the service system 100 and the method 200.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising:
a computer readable storage medium to store a computer readable program, wherein the computer readable program, when executed on a computer, causes the computer to perform operations for modeling a complex service deal, the operations comprising:
presenting a lattice of service elements to a user;
receiving selections from the user to identify selected service elements for inclusion in a complex service deal;
accessing a generic predictive cost model for each selected service element;
defining a specific cost model for each selected service, wherein the specific cost model at least partially depends on the generic predictive cost model for the selected service element in combination with a cost transformation model corresponding to a service delivery center with available resources for fulfilling the corresponding service element.

2. The computer program product of claim 1, wherein the operations further comprise attributing to a particular service element at least a portion of an actual aggregate cost associated with the corresponding service delivery center for fulfilling the particular service element.

3. The computer program product of claim 2, wherein the operations further comprise generating a graphical user interface to receive user input for attributing actual costs of the corresponding service delivery center to the particular service element.

4. The computer program product of claim 2, wherein the operations further comprise storing the actual aggregate cost associated with the corresponding service delivery center in a database of aggregate costs for a plurality of service delivery centers.

5. The computer program product of claim 1, wherein the operations further comprise generating a graphical user interface to receive user input for receiving the selections from the user to identify the selected service elements for inclusion in the complex service deal, wherein the graphical user interface also presents locally relevant dimensions of a particular service delivery center to the user.

6. The computer program product of claim 1, wherein the operations further comprise storing information about prior deals in a database of prior deals, wherein the information comprises the generic predictive cost models for the selected service elements.

7. A computer program product comprising:
a computer readable storage medium to store a computer readable program, wherein the computer readable program, when executed on a computer, causes the computer to perform operations for modeling a complex service deal, the operations comprising:
describing a deal cost model based on a combination of:
generic predictive cost models for corresponding service elements, wherein each service element represents a deliverable service with a defined scope and duration; and
cost transformation models applied to the generic predictive cost models, wherein each cost transformation model corresponds to a service delivery center with available resources for at least partially fulfilling the corresponding service element;
tracking aggregate cost data for at least one service delivery center, wherein the aggregate cost data comprises actual cost data for a plurality of services available through the service delivery center; and
dynamically evaluating accuracy of the deal cost model during the duration of at least one of the service elements by establishing a correlation between a particular service element within the complex service deal and a portion of the aggregate cost data allocated to a particular service delivery center.

8. The computer program product of claim 7, wherein the operations further comprise evaluating a specific cost model for a particular service element, wherein the specific cost model is based on a combination of the generic predictive cost model and the cost transformation model for the particular service element, and the specific cost model comprises:
a volume model for modeling a number of transactions of the corresponding service element; and
a productivity model for modeling a price of each transaction of the volume model, at a constant transaction level.

9. The computer program product of claim 8, wherein the operations further comprise adjusting the volume and productivity models for at least one active service element based on the accuracy of the deal cost model, wherein the active service element has a future expected completion date.

10. The computer program product of claim 9, wherein the operations further comprise maintaining the volume and productivity models unchanged for at least one inactive service element, wherein the inactive service element has a past completion date.

11. The computer program product of claim 7, wherein the operations further comprise:
comparing an aggregate cost for the particular service delivery center with a sum of predicted costs for service elements delivered by the particular service delivery center;
identifying a deviation term to describe a difference between the aggregate cost and the sum of the predicted costs for the service elements delivered by the particular service delivery center; and
identifying an error term based on a set of the identified deviation terms.

12. The computer program product of claim 11, wherein the operations further comprise determining whether the error term is within a range.

13. The computer program product of claim 12, wherein the operations further comprise making an incremental change to a parameter of at least one of the cost transformation models in response to a determination that the error term is outside of the range, wherein the incremental change is subject to a change constraint which limits the incremental change.

14. The computer program product of claim 12, wherein the operations further comprise making an incremental change to a specific predictive cost model for a particular service element in response to a determination that the error term is outside of the range, wherein the specific predictive cost model is at least partially based on a combination of the generic predictive cost model and the cost transformation model for the particular service element, and the incremental change is subject to a change constraint which limits the incremental change.

15. The computer program product of claim 12, wherein the operations further comprise iteratively performing at least two of the following operations until a change in the error term from sequential iterations is below a threshold:
calculating, based on an original volume estimate, a new volume estimate for fulfillment of at least one of the service elements at a selected service delivery center;
determining, based on the new volume estimates, a new cost transformation model corresponding to the selected service delivery center, wherein the new cost transformation model is related to a previous cost transformation model within a first bound; and
determining, based on the new volume estimates, a new specific predictive cost model for the corresponding service element, wherein the new specific predictive cost model is related to a previous specific predictive cost model within a second bound.

16. The computer program product of claim 7, wherein the operations further comprise using the deal cost model to calculate a cost of the complex service deal, wherein the cost comprises:
a historic cost calculation indicative of actual costs attributed to corresponding service elements within the complex service deal through a completed duration of the complex service deal; and
a predictive cost calculation indicative of estimated costs expected to be incurred through a remaining duration of the complex service deal.

17. The computer program product of claim 15, wherein the operations further comprise determining a new generic predictive cost model for the corresponding service element based on a collection of new specific predictive cost models and unchanged specific predictive cost models, wherein a difference between the new generic predictive cost model and a previous generic predictive cost model is limited by a change constraint.

18. A method for modeling a complex service deal, the method comprising:
presenting a lattice of service elements to a user via a new deal interface;
receiving selections from the user via the new deal interface to identify selected service elements for inclusion in the complex service deal;
accessing a generic predictive cost model from a deals database for each selected service element;
defining a specific cost model for each selected service, wherein the specific cost model at least partially depends on the generic predictive cost model for the selected service element in combination with a cost transformation model corresponding to a service delivery center with available resources for fulfilling the corresponding service element.

19. The method of claim 18, further comprising:
generating a graphical user interface to receive user input; and
attributing to a particular service element, based on the user input, at least a portion of an actual aggregate cost associated with the corresponding service delivery center for fulfilling the particular service element.

20. A method for modeling a complex service deal, the method comprising:
describing a deal cost model based on a combination of:
generic predictive cost models for corresponding service elements, wherein each service element represents a deliverable service with a defined scope and duration; and
cost transformation models applied to the generic predictive cost models, wherein each cost transformation model corresponds to a service delivery center with available resources for at least partially fulfilling the corresponding service element;
tracking aggregate cost data for at least one service delivery center, wherein the aggregate cost data comprises actual cost data for a plurality of services available through the service delivery center; and
dynamically evaluating accuracy of the deal cost model during the duration of at least one of the service elements by establishing a correlation between particular service elements within the complex service deal and portions of the aggregate cost data allocated to at least one service delivery center.

21. The method of claim 20, further comprising:
evaluating a specific cost model for a particular service element, wherein the specific cost model is based on a combination of the generic predictive cost model and the cost transformation model for the particular service element.

22. The method of claim 20, further comprising:
comparing an aggregate cost for the particular service delivery center with a sum of predicted costs for service elements delivered by the particular service delivery center;
identifying a deviation term to describe a difference between the aggregate cost and the sum of the predicted costs for the service elements delivered by the particular service delivery center;
identifying an error term based on a set of at least one deviations; and
determining whether the error term is within a range.

23. The method of claim 22, further comprising:
iteratively performing at least two of the following operations until a change in the error term from sequential iterations is below a threshold:
calculating, based on an original volume estimate, a new volume estimate for fulfillment of at least one of the service elements at a selected service delivery center;
determining, based on the new volume estimates, a new cost transformation model corresponding to the selected service delivery center, wherein the new cost transformation model is related to a previous cost transformation model within a first bound; and
determining, based on the new volume estimates, a new specific predictive cost model for the corresponding service element, wherein the new specific predictive cost model is related to a previous specific predictive cost model within a second bound.

24. A deal management system comprising:
a deal specification subsystem with a new deal interface to facilitate user specification of a complex service deal, wherein the complex service deal comprises a plurality of service elements scheduled for fulfillment from a plurality of service delivery centers;
a cost subsystem to track an aggregate cost of a service delivery center that is arranged to fulfill a particular service element; and
an estimation subsystem to dynamically evaluate accuracy of a deal cost model for the complex service deal during a duration of the particular service element by establishing a correlation between service elements within the complex service deal and portions of the aggregate cost data allocated to at least one corresponding service delivery center.

25. The deal management system of claim 24, further comprising a cost transformation subsystem to store a plurality of cost transformation models, wherein each cost transformation model is configured to modify a generic predictive cost model for a specific service element according to known cost factors associated with a specific service delivery center.
